(19) United States
(12) Patent Application Publication
(10) Pub. No.: US 2018/0156430 A1
(43) Pub. Date: Jun. 7, 2018

(54) MOVING HEAD LAMP

(71) Applicant: SGM Light A/S, Aarhus V (DK)

(72) Inventor: Peter Johansen, Aarhus V (DK)

(21) Appl. No.: 15/528,367

(22) PCT Filed: Nov. 20, 2015
(86) PCT No.: PCT/EP2015/077237

§ 371 Date: May 19, 2017

(30) Foreign Application Priority Data
Nov. 20, 2014 (DK) PA 2014 70718

(51) Int. Cl. F21V 21/40; F21V 21/30; F21V 21/15; F21W 131/406

(52) U.S. Cl. CPC F21V 21/406; F21W 2131/406; F21V 21/15; F21V 21/30

(57) ABSTRACT

A moving head lamp comprising: a lamp base adapted for resting on a 5 plane surface and/or for being mounted on a separate structure; a lamp head carrier having a first end being rotatably mounted about a first axis of rotation in relation to the lamp base; a lamp head with a light source, the lamp head being rotatably mounted about a second axis in relation to the lamp head carrier, said second axis being different from, and preferably 10 substantially perpendicular to, said first axis; and a first carrying handle arranged on the lamp head carrier between the lamp head and the lamp base, wherein said carrying handle comprises an elongate grip section extending in its longitudinal direction substantially parallel to said second axis.

### FIELD OF USE OF THE INVENTION

The present invention relates to moving head lamps, and more particularly to a moving head lamp comprising a lamp base adapted for resting on a surface and/or for being mounted on a separate structure, a lamp head carrier having a first end being is rotatably mounted about a first axis of rotation (the panning axis) of rotation in relation to the lamp base and a lamp head with a light source, the lamp head being rotatably mounted about a second axis of rotation (the tilting axis) in relation to the lamp head carrier, said second axis being different from, and preferably substantially perpendicular to, said first axis, and where the moving head lamp further comprises one or more handles arranged for manually lifting and moving the moving head lamp.

### STATE OF THE ART

Moving head lamps of the above mentioned kind are mostly used for providing directed illumination at various venues such as shows, concerts and exhibitions, where they are frequently handled by one or two persons.

These lamps are normally provided with electrical motors as well as power supply and control circuitry adapted for rotating/tilting the lamp head and for rotating/panning the lamp carrier about the second and the first axis of rotation. The lamps are therefore often quite bulky and heavy and therefore difficult to handle.

For this reason handles are mostly provided on the lamp base in order to ensure a good grip for the person handling the lamp. This position, however, is often far below the centre of gravity of the moving head lamps, and is therefore increasing risk that the unit may tilt during handling.

Furthermore due to the increased demand for more powerful illumination the moving head lamps are becoming increasingly larger and heavier and therefore more difficult to handle safely. It is therefore becoming increasingly important that the handles arranged on the moving head lamps are providing easy and secure handling in order to avoid damage to the lamp during handling.

From e.g. U.S. Pat. No. 7,789,543 and from US patent application no. 2009/0323364 lamps of the above mentioned kind are disclosed having a yoke arranged for carrying the moving lamp head, and where the carrying handles are provided on top of the yoke above the moving lamp head, and on the bottom of the yoke below the moving lamp head.

### OBJECT OF THE INVENTION

On this background it is the object of the present invention to provide a moving head lamp with a carrying handle arranged for even more safe handling of the lamp.

According to the invention this is achieved by arranging a carrying handle on the lamp head carrier between the lamp head and the lamp base, and with the carrying handle comprising an elongate grip section extending in its longitudinal direction substantially parallel to the axis of rotation of the lamp head.

Thereby it is possible to easily carry the moving head lamp so that all lamp parts are lifted safely from the ground and at the same time reducing the risk that the lamp tilts during handling.

In a preferred embodiment of the invention the lamp carrier is formed as a substantially U-shaped yoke having a mid-section and two mutually parallel legs extending from opposite ends of the mid-section, and the mid-section of the yoke is rotatably mounted to the lamp base so that the two legs extends away from the lamp base, and where the lamp head is rotatably mounted between said two legs.

The mid-section of the U-shaped yoke may preferably have a first side face being substantially parallel with said second axis, and the first carrying handle arranged thereon.

Furthermore the mid-section of the U-shaped yoke further may also comprise a second side face being substantially parallel with said second axis, and wherein a second carrying handle is arranged on the second side face, the second handle comprising an elongate grip section extending in its longitudinal direction substantially parallel to said second axis.

In this relation the elongate grip section may advantageously be fixed to its associated side face at positions close to the transition between the mid-section and each leg of the U-shaped yoke.

Furthermore each carrying handle may preferably be shaped so that the distance from the first axis of rotation to the outermost part of the carrying handle, measured in a direction perpendicular to the first axis of rotation, is smaller than the corresponding distance to the outermost part of the U-shaped yoke.

In a further preferred embodiment of the invention the outermost part of the lamp base measured in a direction perpendicular to the first axis of rotation, is larger than the corresponding distance to the outermost part of the U-shaped yoke.

The lamp base may in this relation have at least one section where its outermost distance, measured in a direction perpendicular to the first axis of rotation, corresponds to the innermost distance of the first or the second side face on the U-shaped yoke measured in the same direction.

In a further preferred embodiment the lamp head carrier may advantageously comprise a housing assembly enclosing mechanical and electrical components inside, and the housing assembly comprising at least a first and a second housing part separated along a parting line, and where said parting line extends along at least a part of the elongate grip section of the carrying handle.

The moving head lamp may comprise all electrical motors as well as control circuitry and power supply necessary for rotating (panning and tilting) the lamp head and the lamp head carrier respectively about said first and second axis of rotation.

In this relation the present invention is especially advantageous when used in moving head lamps where the power supply comprises one or more electrical and preferably rechargeable batteries arranged in the lamp base.

### LIST OF FIGURES

FIG. 1 is a perspective view of a moving head lamp according to the present invention.

FIG. 2 is a front side view of the moving head lamp shown in FIG. 1.

### EMBODIMENT OF THE INVENTION

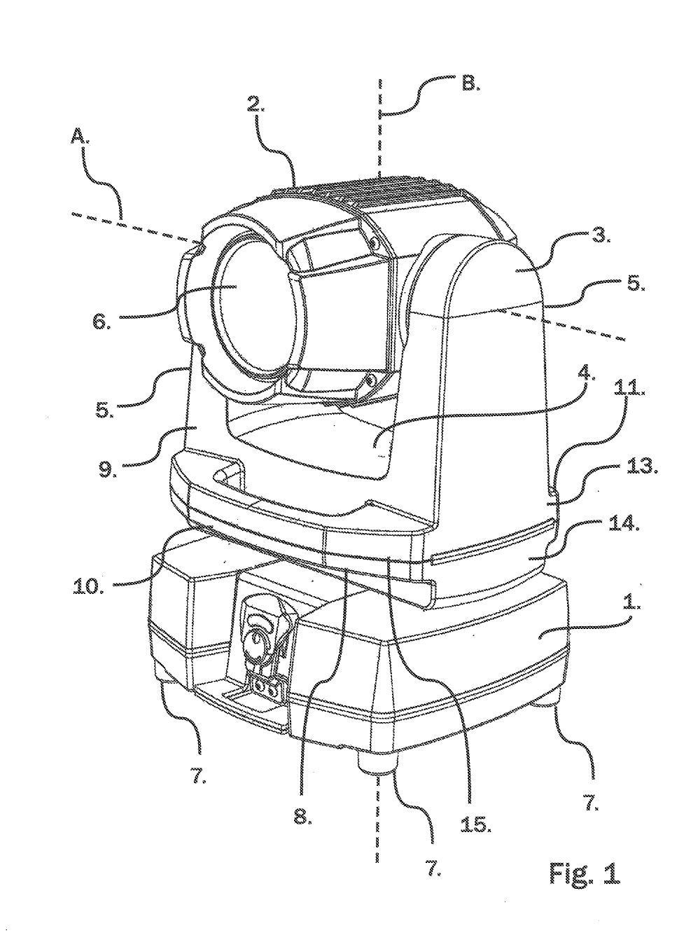

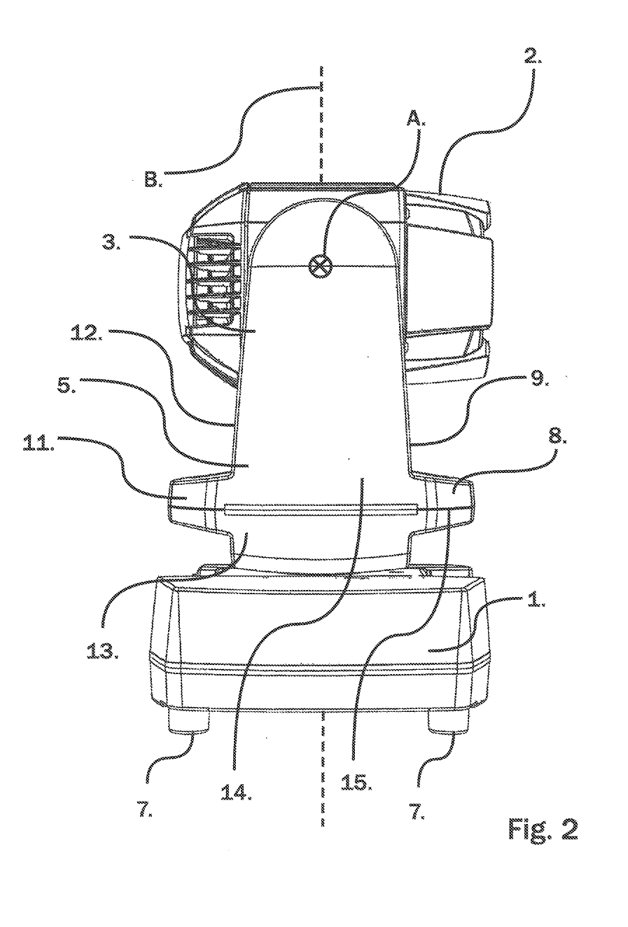

Thus, FIGS. 1 and 2 shows the same moving head lamp having a lamp base 1 with a set of feet 7 allowing it to rest on a plane support, a lamp head 2 and a yoke 3 having a mid-section 4 and two legs 5 extending upwardly from the mid-section 4. The lamp head 2 is tiltable with respect to the yoke 3 about the axis (second axis) A shown on the figure, and it contains at least a light source for projecting a light beam out of the opening 6 formed by an optical element 6 which might be replaced e.g. by another light source such as an LED array or other lighting arrangement providing a beam of light concentrated in a selected direction.

The yoke 3 hereby carries the lamp head 2 and as the yoke 3 is mounted on the lamp base 1 so that it can rotate (pan) about the axis (first axis) B shown on the figure, then it is possible to direct the light beam provided by the lamp head 2 in any direction only limited by the physical and mechanical structure of the moving head lamp 1.

For this purpose one or more electrical motors, gearing, control circuitry and power supply is built into the lamp parts 1, 2 and 3. These elements are not, however, shown on the figures as it will be apparent to the skilled person how such elements may be implemented in many different embodiments. In the preferred embodiment, however, the moving head lamp comprises one or more electrical and preferably rechargeable batteries forming at least a part of the power supply. By arranging such batteries in the lamp base 1 the height of the centre of gravity of the lamp is reduced significantly. According to the invention a first carrying handle 8 is arranged on a first side face 9 on the yoke 3, and the carrying handle 8 has an elongate grip section 10 extending in its longitudinal direction parallel to the tilting axis A so that when a single person carries the moving head lamp using only one hand, then one of the legs 5 of the yoke is placed away from the person carrying the moving head lamp, and thereby protects the lamp head from striking obstacles e.g. when passing a very narrow door passage or the like.

In the embodiment shown on the figures the yoke is also provided with a similar second carrying handle 11 arranged on the opposite side 12 of the yoke 3. As shown in FIG. 2 especially this second carrying handle 11 is also mounted on a (second) side face 12 and has an elongate grip section extending in its longitudinal direction parallel to the tilting axis A of the lamp head. This allows single person carrying the moving head lamp to select which handle he prefers to use e.g. in order to ensure that the optics 6 or other fragile lighting components are directed upwardly when carrying the unit in one hand. This embodiment also provides the option of a single person carrying the moving head lamp using two hands, or two person carrying the unit, such as it is normally done with moving head lamps having handles arranged on the lamp base. In this relation the higher position of the handles 8, 11 according to the invention, and especially in combination with the use of electrical batteries arranged in the lamp base 1 provides much more stability against tilting the unit over.

In the preferred embodiment shown on the figures the handles 8, 11 are connected to the yoke 3 at each end of the elongate section 10 of each handle 8, 11.

The housing enclosing the mechanical and electrical components of the yoke 3 comprises two housing parts 13, 14 that are engaging each other via the parting line 15 extending along the elongate section of each of the carrying handles. Thereby the two shell parts are held firmly against each other during handling of the moving head lamp, so that the housing parts 13, 14 are protected against deformations during transportation.

As can be seen from the figures the distance away from the panning (first) axis B of the outermost part of the lamp base 1, is larger than the corresponding distance of the outermost part of the yoke 3 and this last mentioned distance is again larger than the corresponding distance of the outermost part of the handles 8, 11. Thereby the yoke 3 and or the handles 8, 11 are protected against striking obstacles surrounding the moving head lamp when the yoke is pans/rotates about the panning (first) axis B.

In the claims enumerating several features, some or all of these features may be embodied by one and the same element, component or item. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

1. A moving head lamp comprising:
a lamp base adapted for resting on a plane surface and/or for being mounted on a separate structure;
a lamp head carrier having a first end being rotatably mounted about a first axis of rotation in relation to the lamp base;
a lamp head with a light source, the lamp head being rotatably mounted about a second axis in relation to the lamp head carrier, said second axis being different from, and preferably substantially perpendicular to, said first axis;
electrical motors as well as control circuitry and power supply arranged for rotating the lamp head and the lamp head carrier respectively about said first and second axis of rotation;
a first carrying handle arranged on the lamp head carrier between the lamp head and the lamp base, wherein said carrying handle comprises an elongate grip section extending in its longitudinal direction substantially parallel to said second axis.

2. A moving head lamp according to claim 1, wherein said lamp carrier is formed as a substantially U-shaped yoke having a mid-section and two mutually parallel legs extending from opposite ends of the mid-section, and where the mid-section of the yoke is rotatably mounted to the lamp base so that the two legs extends away from the lamp base, and the lamp head is rotatably mounted between said two legs.

3. A moving head lamp according to claim 2, wherein said mid-section of the U-shaped yoke has a first side face being substantially parallel with said second axis, and where the first carrying handle is arranged on the first side face.

4. A moving head lamp according to claim 3, wherein said mid-section of the U-shaped yoke further comprises a second side face being substantially parallel with said second axis, and wherein a second carrying handle is arranged on the second side face, the second handle comprising an elongate grip section extending in its longitudinal direction substantially parallel to said second axis.

5. A moving head lamp according to claim 3, wherein each end of said elongate grip section is fixed to its associated side face at positions close to the transition between the mid-section and each leg of the U-shaped yoke.

6. A moving head lamp according to claim 3, wherein each carrying handle is shaped so that the distance from the first axis of rotation to the outermost part of the carrying handle measured in a direction perpendicular to the first axis of rotation, is smaller than the corresponding distance to the outermost part of the U-shaped yoke.

7. A moving head lamp according to claim 6, wherein the outermost part of the lamp base measured in a direction perpendicular to the first axis of rotation, is larger than the corresponding distance to the outermost part of the U-shaped yoke.

8. A moving head lamp according to claim 7, wherein the lamp base have at least one section where its outermost distance, measured in a direction perpendicular to the first axis of rotation, corresponds to the innermost distance of the first or the second side face on the U-shaped yoke measured in the same direction.

9. A moving head lamp according to claim 1, wherein said lamp head carrier comprises a housing assembly with at least a first and a second housing part separated along a parting line, and where said parting line extends along at least a part of the elongate grip section of the carrying handle.

10. (canceled)

11. A moving head lamp according to claim 1, wherein the power supply comprises one or more electrical and preferably rechargeable batteries arranged in the lamp base.

12. A moving head lamp according to claim 4, wherein each end of said elongate grip section is fixed to its associated side face at positions close to the transition between the mid-section and each leg of the U-shaped yoke.

13. A moving head lamp according to claim 4, wherein each carrying handle is shaped so that the distance from the first axis of rotation to the outermost part of the carrying handle measured in a direction perpendicular to the first axis of rotation, is smaller than the corresponding distance to the outermost part of the U-shaped yoke.

14. A moving head lamp according to claim 5, wherein each carrying handle is shaped so that the distance from the first axis of rotation to the outermost part of the carrying handle measured in a direction perpendicular to the first axis of rotation, is smaller than the corresponding distance to the outermost part of the U-shaped yoke.

15. A moving head lamp according to claim 2, wherein said lamp head carrier comprises a housing assembly with at least a first and a second housing part separated along a parting line, and where said parting line extends along at least a part of the elongate grip section of the carrying handle.

16. A moving head lamp according to claim 3, wherein said lamp head carrier comprises a housing assembly with at least a first and a second housing part separated along a parting line, and where said parting line extends along at least a part of the elongate grip section of the carrying handle.

17. A moving head lamp according to claim 4, wherein said lamp head carrier comprises a housing assembly with at least a first and a second housing part separated along a parting line, and where said parting line extends along at least a part of the elongate grip section of the carrying handle.

18. A moving head lamp according to claim 5, wherein said lamp head carrier comprises a housing assembly with at least a first and a second housing part separated along a parting line, and where said parting line extends along at least a part of the elongate grip section of the carrying handle.

19. A moving head lamp according to claim 6, wherein said lamp head carrier comprises a housing assembly with at least a first and a second housing part separated along a parting line, and where said parting line extends along at least a part of the elongate grip section of the carrying handle.

20. A moving head lamp according to claim 7, wherein said lamp head carrier comprises a housing assembly with at least a first and a second housing part separated along a parting line, and where said parting line extends along at least a part of the elongate grip section of the carrying handle.

21. A moving head lamp according to claim 9, wherein said lamp head carrier comprises a housing assembly with at least a first and a second housing part separated along a parting line, and where said parting line extends along at least a part of the elongate grip section of the carrying handle.
